(19) United States
(12) Patent Application Publication
(10) Pub. No.: US 2014/0196915 A1
(43) Pub. Date: Jul. 17, 2014

(54) HOOF COVER

(71) Applicant: Fair Mare Products, LLC, Bonita Springs, FL (US)

(72) Inventor: Susan LYON, Bonita Springs, FL (US)

(73) Assignee: Fair Mare Products, LLC, Bonita Springs, FL (US)

(21) Appl. No.: 14/153,531

(22) Filed: Jan. 13, 2014

Related U.S. Application Data
(60) Provisional application No. 61/752,750, filed on Jan. 15, 2013.

(51) Int. Cl. A01L 15/00

(52) U.S. Cl. CPC A01L 15/00
USPC 168/2

(57) ABSTRACT

Described in this application for patent is a cover for treating the hoof or leg of a hooved animal. The cover includes a hoof shoe and a sock joined at a seam. The hoof shoe includes a pocket for receiving the hoof of the animal and provides a continuous outer surface for enclosing the hoof and a cushioned bottom portion allowing for treatment to the underside of the hoof. The sock includes a liner, such as silicone or thermoplastic polyurethane, which adheres to the skin or hair of the animal and prevents the cover from being displaced during wear.

### CROSS-REFERENCE TO RELATED APPLICATIONS

This application claims priority to and the benefit of U.S. Provisional Patent Application No. 61/752,750, filed Jan. 15, 2013, the disclosure of which is incorporated here by reference.

### BACKGROUND AND SUMMARY

This invention is a novel apparatus and method for treating and covering the hoof and lower leg of a livestock animal, such as a horse. More specifically, the invention is a combination hoof shoe and sock for holding the shoe in place on a hoof and treating a wounded animal.

Hoof shoes are commonly provided for treating leg injuries to horses and other animals who cannot avoid walking on the injured limb. The hoof shoes enclose the hoof, providing a barrier between the injured limb and the surface on which the animal may ambulate, and are often padded to prevent further injury to the hoof or leg while the injury is being treated. The hoof shoes may also include a pad or pocket for receiving a medicated substance, such as an ointment or cream, allowing the injury to be treated while the animal ambulates.

A variety of methods of attaching and securing a hoof shoe to an injured foot and/or leg have been proposed and include physical engagement, fasteners inserted into the hoof structure, wrappings, and other types of engagement.

Occasionally animals will have an injury that extends beyond the hoof to the leg of the animal. It may therefore be desirous to secure an elongated sock to the leg of the animal to treat the injury.

Presently disclosed is a hoof cover for administering a medication to a animal hoof,. The hoof cover may include a flexible rubber boot shaped to receive a hoof; and a fabric sock secured to the rubber boot at a seam, whereby the fabric sock is lined with a material for adhering to the leg of the horse to keep the sock in position. In one embodiment, the liner may include silicone. In another embodiment, the liner may include thermoplastic polyurethane. In various embodiments, the seam of the hoof cover may be sewn, glued, or hot fused.

Also disclosed is a method of treating a hoof and leg. The method may include the steps of applying a medication to a hoof; securing a hoof shoe about said hoof; and securing a sock to said leg, wherein said sock is connected to said hoof shoe. In embodiments of the method, the sock may be connected to said hoof shoe at a seam, and the seam may be sewn, glued or hot fused. In embodiments, hoof shoe includes flexible rubber and the sock comprises lined fabric. The may be lined with silicone or a thermoplastic polyurethane. In some embodiments, the hoof shoe includes a closed bottom portion. The closed bottom portion may be cushioned. The closed bottom portion may also be a medicated pad. The closed bottom portion may also be a viscoelastic material.

Also disclosed is a cover for treating the hoof or leg of a hooved animal that includes a hoof shoe including a pocket for receiving a hoof, a continuous outer surface for enclosing a hoof, and a cushioned bottom portion for allowing treatment to the underside of the hoof; and a sock connected to the hoof shoe at a seam, the sock comprising a stretchable fabric having a liner that adheres to the skin or hair of an animal; wherein the hoof shoe and sock keep a medication applied to the hoof or leg of a hooved animal in contact with said hoof or leg. In some embodiments, the hoof shoe may be a flexible elastic rubber.

### BRIEF DESCRIPTION OF DRAWINGS

FIG. 1 is a side view of a horse wearing a hoof cover according to the present invention.

FIG. 2 is a front view of the hoof cover according to the present invention.

FIG. 3 is a side view of the hoof cover according to the present invention.

### DETAILED DESCRIPTION OF DRAWINGS

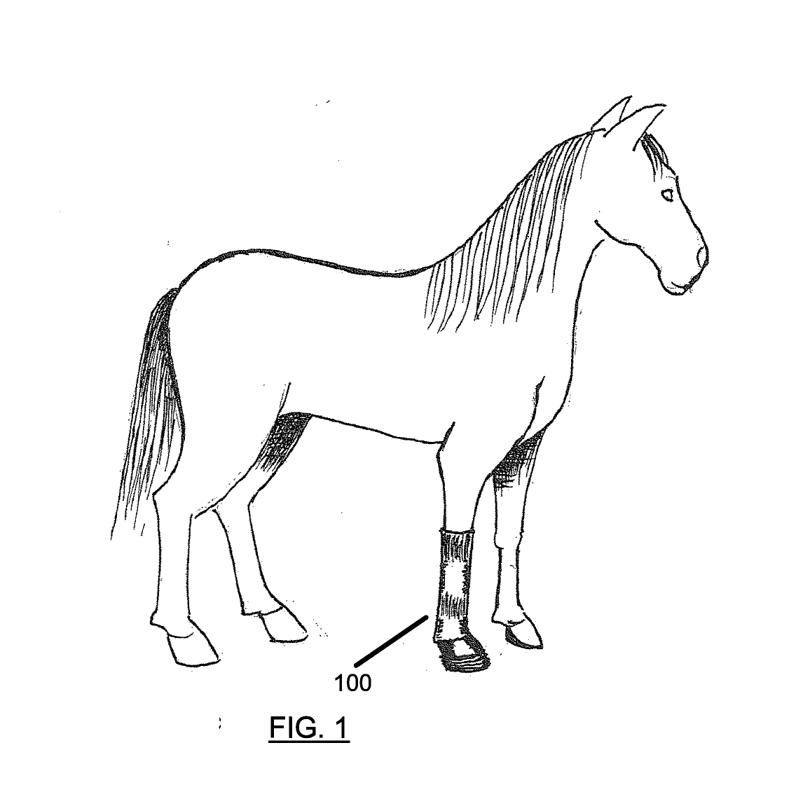

Referring generally to FIGS. 1-3, embodiments of a hoof cover are disclosed. The hoof cover may be utilized for hoof restoration including the application of medicines to the hoof of an animal. In some embodiments, the hoof cover may be staples and configured for easy application and removal without restricting circulation in the animal's leg or hoof. In some embodiment, the hoof cover may be waterproof to protect the animal from dirt and moisture, or to retain moisture or medicines within the cover for treatment of various ailments. The hoof cover may be lightweight facilitating use by the caregiver and comfort for the animal. The hoof cover may be used as a temporary aid in the treatment and protection of the lower leg and hoof, and may be used to rejuvenate and hydrate dry, cracked hoofs when used as a hoof conditioner.

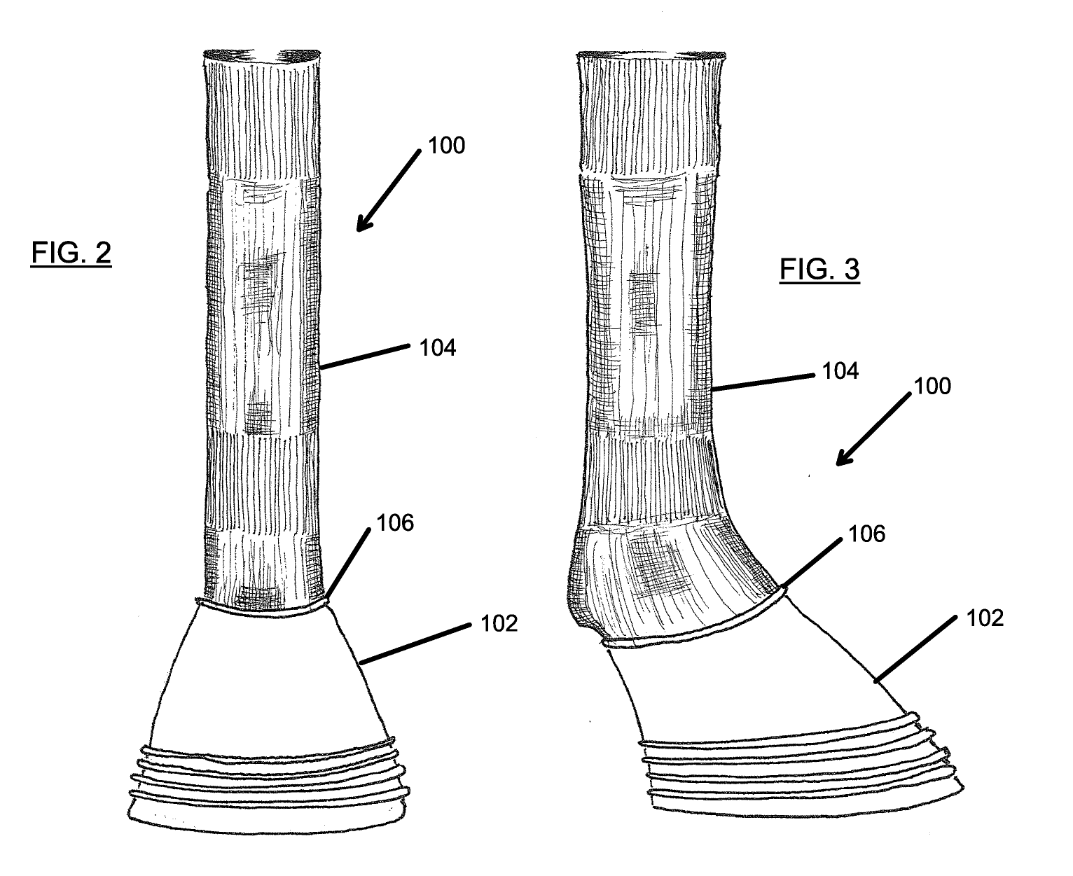

Shown in FIG. 1 is a side view of a horse wearing a hoof cover as presently disclosed. As shown in FIGS. 2-3, the hoof cover 100 includes a hoof shoe 102 and leg sock 104 coupled at a seam 106. The hoof shoe 102 is sized and shaped to receive the hoof of a horse or other hooved animal and the leg sock 104 is sized and shaped to receive the lower limb of a horse or the like.

According to the present disclosure, the hoof shoe 102 is formed from an elastic material, such as flexible rubber, and has a pocket for receiving a hoof. In order to secure the shoe onto the hoof of an animal, the shoe 102 may be stretched open and the hoof inserted within the pocket. Once the hoof has been received in the pocket of the shoe 102, the shoe 102 may be released and return to its original shape. The original shape of the shoe 102 encloses the hoof within the pocket and provides a space for medication or the like. The shoe 102 includes a continuous outer surface, allowing for shoe to fully enclose the hoof and provide medication to the desired portion of the hoof.

In the illustrated embodiment, the hoof shoe 102 fully encloses the hoof and includes a closed bottom. The closed bottom provides a cushion for the hoof of the animal and allows for treatment of the underside of the hoof. Within the closed bottom may be a viscoelastic material adapted to define and fill voids within the hoof and provide a comfortable pad for the animal to walk on. Also provided within the closed bottom may be a medicated pad or porous material for receiving a medication.

Connected to the hoof shoe 102 at a seam 106 is a leg sock 104 that is formed of a flexible material that grabs and adheres to the leg of the animal being treated. The leg sock 104 is designed to extend along the leg of the animal from the hoof towards the knee. In one embodiment, the sock 104 extends above the knee while in a second embodiment the sock 104 ends below the knee. The sock 104 is formed of a silicone or thermoplastic polyurethane lined fabric. The fabric is flexible and allows the sock 104 to adapt to the various contours and shape of the animal leg between the hoof and knee. The silicone or thermoplastic polyurethane lining along the inside of the sock 104 is provided to allow the sock to adhere to the leg of the animal.

According to the embodiment illustrated in FIGS. 2-3, the hoof shoe 102 is permanently connected to the leg sock 104 at a seam 106. This seam forms a combination leg sock and hoof shoe that is a continuous piece that cannot be attached to the animal separately. The seam 106 may be formed by gluing or hot fusing the leg sock 104 to the boot 102. Other types of permanently seam formation are also contemplated, including stitching or other type of permanent seal.

According to the illustrated embodiment, the seam 106 is provided at the joint between the hoof shoe 102 and leg sock 104. In this embodiment, the leg sock 104 does not overlap the shoe 102 and the seam 106 is provided on the outside of the shoe. However, other embodiments are also contemplated where the sock 104 and shoe 102 overlap. According to one embodiment, the leg sock 104 extends into the shoe 102 and a seam 106 is provided on the inside of the shoe 102. Alternatively, the leg sock 104 may extend along the outside of the shoe 102 and the seam 106 may be provided on the outside of the shoe.

Application of the hoof cover to an animal may be accomplished by the following steps. First, the leg sock 104 of the hoof cover 100 is rolled down or inverted over the hoof shoe 102. Next, the hoof shoe 102 is stretched to receive the hoof of the animal to be treated. Then the hoof of the animal is inserted into the hoof shoe 102. The hoof shoe 102 is released and returned to its original shape by the elastic nature of the shoe, enclosing the hoof within a pocket of the hoof shoe 102. Finally, the leg sock 104 is rolled over the hoof shoe 102 and onto the leg of the animal to be treated. The leg sock 104 may extend to a point below, at, or above the knee of the animal to be treated. The leg sock 104 includes a liner, such as silicone or thermoplastic polyurethane, that adheres to the skin or hair of the animal, keeping the sock in position. The shoe 102 is held in place by the leg sock 104 and the elastic properties of the shoe, which is shaped to receive the hoof of the animal.

In the above described method, the hoof shoe 102 is connected to the leg sock 104 at a seam 106 that provides a continuous inner surface for receiving a hoof and portion of the leg of the animal to be treated. The continuous inner surface allows a medication, such as an ointment, to be applied to the leg, hoof, or both, and prevents the medication from losing contact with the limb. The shoe 102 and sock 104 combination also provides a barrier against foreign material, such as dirt, stones, or water, from contacting the animal's limb during regular movement. The shoe 102 and sock 104 are constructed of flexible materials that allow the animal to use the limb in a normal manner without discomfort, pain, or difficulty. Finally, the combined sock and shoe are easy to apply and secure to the animal, reducing discomfort of the animal during application and time for the individual securing the sock.

While certain embodiments have been described, it must be understood that various changes may be made and equivalents may be substituted without departing from the spirit or scope of the present disclosure. In addition, many modifications may be made to adapt a particular situation or material to the teachings of the disclosure without departing from its spirit or scope.

What is claimed is:

1. A hoof cover for administering a medication to a animal hoof, the cover comprising:
a flexible rubber boot shaped to receive a hoof; and
a fabric sock secured to the rubber boot at a seam, whereby the fabric sock is lined with a material for adhering to the leg of the horse to keep the sock in position.

2. The hoof cover of claim 1 wherein said liner comprises silicone.

3. The hoof cover of claim 1 wherein said liner comprises thermoplastic polyurethane.

4. The hoof cover of claim 1 wherein the seam is sewn.

5. The hoof cover of claim 1 wherein the seam is glued.

6. The hoof cover of claim 1 wherein the seam is hot fused.

7. A method of treating a hoof and leg, the method comprising the steps of:
applying a medication to a hoof;
securing a hoof shoe about said hoof; and
securing a sock to said leg, wherein said sock is connected to said hoof shoe.

8. The method of claim 7 wherein the sock is connected to said hoof shoe at a seam.

9. The method of claim 8 wherein the seam is sewn.

10. The method of claim 8 wherein the seam is glued.

11. The method of claim 8 wherein the seam is hot fused.

12. The method of claim 11 wherein the hoof shoe comprises flexible rubber and the sock comprises lined fabric.

13. The method of claim 12 wherein the sock is lined with silicone.

14. The method of claim 12 wherein the sock is lined with a thermoplastic polyurethane.

15. The method of claim 11 wherein the hoof shoe includes a closed bottom portion.

16. The method of claim 15 wherein the closed bottom portion is cushioned.

17. The method of claim 16 wherein the closed bottom portion is a medicated pad.

18. The method of claim 16 wherein the closed bottom portion is a viscoelastic material.

19. A cover for treating the hoof or leg of a hooved animal, the cover comprising:
a hoof shoe including a pocket for receiving a hoof, a continuous outer surface for enclosing a hoof, and a cushioned bottom portion for allowing treatment to the underside of the hoof; and
a sock connected to the hoof shoe at a seam, the sock comprising a stretchable fabric having a liner that adheres to the skin or hair of an animal;
wherein the hoof shoe and sock keep a medication applied to the hoof or leg of a hooved animal in contact with said hoof or leg.

20. The cover of claim 19 wherein the hoof shoe is a flexible elastic rubber.
